(19) United States
(12) Patent Application Publication
(10) Pub. No.: US 2026/0222489 A1
(43) Pub. Date: Jul. 30, 2026

(54) SYSTEMS AND METHODS FOR CONTEXT AWARE TRANSCRIPTION OF IDENTIFIERS

(71) Applicant: KORE.AI, INC., Orlando, FL (US)

(72) Inventors: Rajkumar KONERU, Windermere, FL (US); Prasanna Kumar ARIKALA GUNALAN, Hyderabad (IN); Vishnu Kumar NEKKANTI, Orlando, FL (US)

(21) Appl. No.: 19/039,562

(22) Filed: Jan. 28, 2025

(51) Int. Cl. H04M 3/42; G10L 15/26

(52) U.S. Cl. CPC H04M 3/42221; G10L 15/26

(57) ABSTRACT

An automation server receives, from a user device, a voice utterance comprising an identifier in response to a request to provide the identifier. The automation server sequentially produces a sequence of intermediate audio outputs based on the received voice utterance, wherein each of the intermediate audio outputs is provided as an input to a next one in the sequential production. A final audio output is generated by combining the intermediate audio outputs. The identifier is determined with a language model from the final audio output. Subsequently, an automation is performed based on a transcribed text of the determined identifier.

### FIELD

This technology generally relates to speech to text systems, and more particularly to methods, systems, and computer-readable media for context aware transcription of identifiers.

### BACKGROUND

Existing speech-to-text (STT) solutions are primarily designed and optimized for transcribing natural language speech encountered in everyday conversations. These solutions convert spoken words from phone calls or other voice-based interactions into text, particularly when the speech contains common vocabulary and phrases. Typical STT systems achieve this through training on datasets of conversational speech, where the models learn to predict and generate text that resembles the natural language patterns found in such interactions.

However, conventional STT systems encounter significant challenges when used in scenarios where conversations contain specialized or non-standard identifiers in the interaction. For example, in many contact center interactions, customers frequently provide unique identifiers—such as usernames, employee IDs, or product IDs - that are essential for authentication or task-specific processing. Unlike common vocabulary, these identifiers often consist of alphanumeric sequences, special characters, or phonetic spellings that do not follow standard linguistic patterns. Examples include usernames like “jon.smith04,” employee IDs such as “ABC04980,” and product codes like “Acme ST650.” These identifiers are highly variable and are not typically included in the natural language datasets used to train existing STT models, making it difficult for these solutions to accurately transcribe them.

Despite certain STT systems offering customization options that allow users to input additional training data, these options remain insufficient for accurate transcription of identifiers. The unique and diverse nature of identifiers prevents reliable recognition, resulting in frequent misinterpretations by STT models. For example: A spoken identifier like “jon.smith02” may be transcribed inaccurately as “john dot smith zero two” or “john dot smith02.” When spelled out character-by-character (“j o n d o t s m i t h 0 2”), it may be transcribed as “jon dot smi th 0 two” or “jon dot smith02.” Similarly, “Acme S T 650” may be misrecognized as “Acme HT 650,” leading to critical errors in subsequent automated processing.

These transcription errors have significant implications, especially in environments like contact centers, where accurate identifier recognition is critical to initiating automated workflows. The inability of current STT solutions to handle such identifiers forces contact centers to rely on human agents to verify and manually input these identifiers, thus impeding automation efforts, increasing operational costs, and limiting scalability.

Accordingly, there is a need for an improved speech-to-text solution capable of accurately transcribing identifiers such as usernames, employee IDs, and product codes, even when these identifiers do not conform to natural language patterns.

### SUMMARY

In one example, the present disclosure relates to a method for determining an identifier in a voice communication session comprising receiving from a user device a voice utterance comprising the identifier in response to a request to provide the identifier. The automation server sequentially produces a sequence of intermediate audio outputs based on the received voice utterance, wherein each of the intermediate audio outputs is provided as an input to a next one in the sequential production. A final audio output is generated by combining the intermediate audio outputs. The identifier is determined with a language model from the final audio output. Subsequently, an automation is performed based on a transcribed text of the determined identifier.

In another example, the present disclosure relates to an automation server for determining an identifier comprising one or more processors and a memory. The memory coupled to the one or more processors which are configured to execute programmed instructions stored in the memory to receive a voice utterance from a user device comprising the identifier in response to a request to provide the identifier. The automation server sequentially produces a sequence of intermediate audio outputs based on the received utterance, wherein each of the intermediate audio outputs is provided as an input to a next one in the sequential production. A final audio output is generated by combining the intermediate audio outputs. The identifier is determined with a language model from the final audio output. Subsequently, an automation is performed based on a transcribed text of the determined identifier.

In another example, the present disclosure relates to a non-transitory computer readable storage medium storing thereon instructions which when executed by one or more processors, causes the one or more processors to receive a voice utterance from a user device comprising the identifier in response to a request to provide the identifier. The automation server sequentially produces a sequence of intermediate audio outputs based on the received utterance, wherein each of the intermediate audio outputs is provided as an input to a next one in the sequential production. A final audio output is generated by combining the intermediate audio outputs. The identifier is determined with a language model from the final audio output. Subsequently, an automation is performed based on a transcribed text of the determined identifier.

### BRIEF DESCRIPTION OF THE DRAWINGS

FIG. 1 is a block diagram of an exemplary speech to text environment for implementing the concepts and technologies disclosed herein.

FIG. 2 is a flowchart of an exemplary method for context aware transcription of identifiers.

FIG. 3A is an exemplary interaction diagram illustrating a voice call between an automation server and a user device.

FIG. 3B is another exemplary interaction diagram illustrating a voice call between the automation server and the user device.

### DETAILED DESCRIPTION

Examples of the present disclosure relate to a speech-to-text (STT) environment and, more particularly, to one or more components, systems, computer-readable media, and methods for context aware transcription of identifiers. The STT environment is configured to perform a number of operations as illustrated and described by way of the examples herein accurately transcribe identifiers from speech.

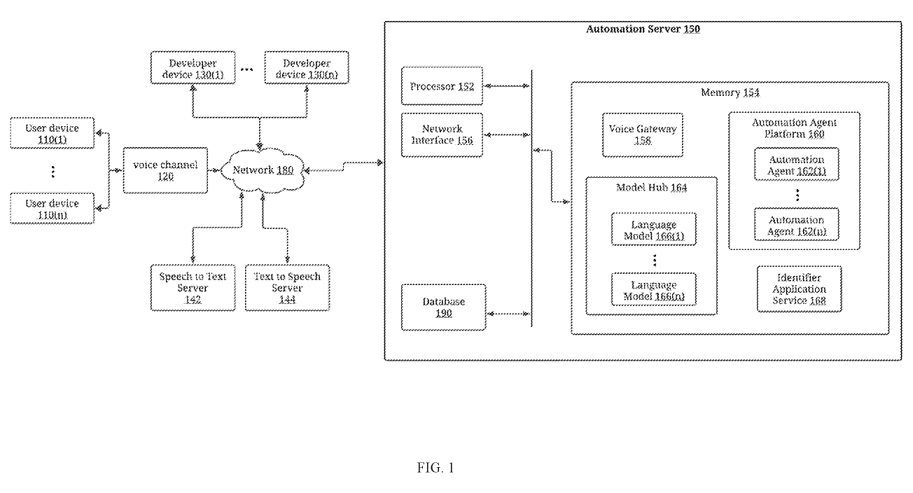

FIG. 1 is a block diagram of an exemplary STT environment 100 for implementing examples of the concepts and technologies disclosed herein. The STT environment 100 includes: one or more user devices 110(1)-110(n), one or more developer devices 130(1)-130(n), a voice channel 120, a speech-to-text (STT) server 142, a text-to-speech (TTS) server 144, and an automation server 150 coupled together via a network 180, although the STT environment 100 can include other types and/or numbers of systems, devices, components, and/or elements in other examples. Although not shown, the exemplary STT environment 100 may include additional network components, such as gateways, routers, switches and other devices, which are well known to those of ordinary skill in the art and thus will not be described here.

Referring to FIG. 1, in this example the automation server 150 manages incoming communication from the one or more user devices 110(1)-110(n). The automation server 150 may use automation, human agents, or a combination of these to respond to the incoming communication and resolve issues of users. In one example, the automation server 150 may use artificial intelligence techniques to perform the automation.

The one or more user devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more user devices 110(1)-110(n) may have other types and/or numbers of other systems, devices, components, and/or elements in other examples. The users accessing the one or more user devices 110(1)-110(n) provide voice utterances via a voice channel 120 to the automation server 150. Examples of the voice channel 120 may include telephone calls made over mobile phones or landlines, voice over IP or VoIP calls, although there may be other types and/or numbers of technologies in other examples.

The one or more developers may access and interact with the functionalities exposed by the automation server 150 via the network 180 using the one or more developer devices 130(1)-130(n). The one or more developer devices 130(1)-130(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 130(1)-130(n) may include software and hardware capable of communicating with the automation server 150 via the network 180. Also, the one or more developer devices 130(1)-130(n) may comprise a graphical user interface (GUI) (not shown) to render and display the information received from the automation server 150. The one or more developer devices 130(1)-130(n) may communicate with the automation server 150 via one or more application programming interfaces (APIs) or one or more hyperlinks exposed by the automation server 150, although other types and/or numbers of communication methods may be used in other examples.

The network 180 enables the components of the STT environment 100 to communicate with the automation server 150. The network 180 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although the network 180 may include other types and/or numbers of networks in other topologies or configurations.

The automation server 150 includes a processor 152, a memory 154, and a network interface 156, although the automation server 150 may include other types and/or numbers of components in other examples. Although one processor 152, one memory 154, and one network interface 156 are illustrated, it may be understood that there may be a plurality of: processor 152, memory 154, or network interface 156 components in other examples. In addition, the automation server 150 may include an operating system (not shown). In one example, the automation server 150 and/or processes performed by the automation server 150 may be implemented using a networking environment (e.g., cloud computing environment) or offered as a service through the cloud computing environment.

The components of the automation server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although the components of the automation server 150 may be coupled using other types and/or numbers of buses or systems in other examples. In one example, the components of the automation server 150 may be operatively or communicatively coupled with each other.

The processor 152 of the automation server 150 may execute one or more computer-executable instructions stored in memory 154 for developing conversational artificial intelligence applications using automation agents, such as the methods illustrated and described with reference to the examples herein, although the processor 152 can execute other types and/or numbers of instructions and perform other types and/or numbers of operations. The processor 152 may comprise one or more central processing units (CPUs), or general-purpose processors with a plurality of processing cores, such as Intel® processor(s), AMD® processor(s), although other types and/or numbers of processor(s) could be used in other configurations.

The memory 154 of the automation server 150 is an example of a non-transitory computer readable storage medium capable of storing information or instructions for the processor 152 to operate on. The instructions, which when executed by the processor 152, perform one or more processes for developing conversational artificial intelligence applications such as one or more of the disclosed examples. In one example, the memory 154 may be a random access memory (RAM), a dynamic random access memory (DRAM), a static random access memory (SRAM), a persistent memory (PMEM), a nonvolatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a solid state memory, a compact disc (CD), a digital video disc (DVD), a magnetic disk, a universal serial bus (USB) memory card, a memory stick, or any other memory storage types or devices, including combinations thereof, which are known to those of ordinary skill in the art. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

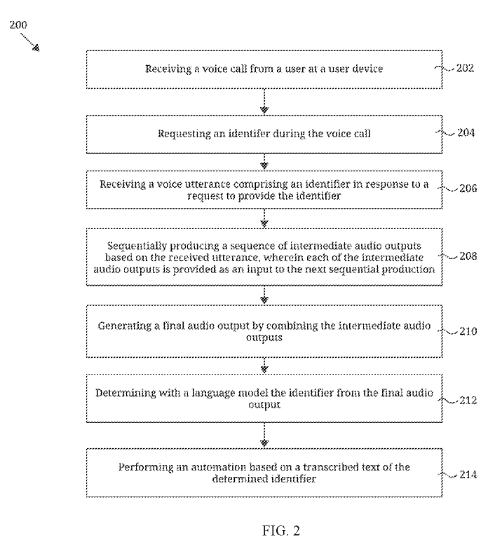

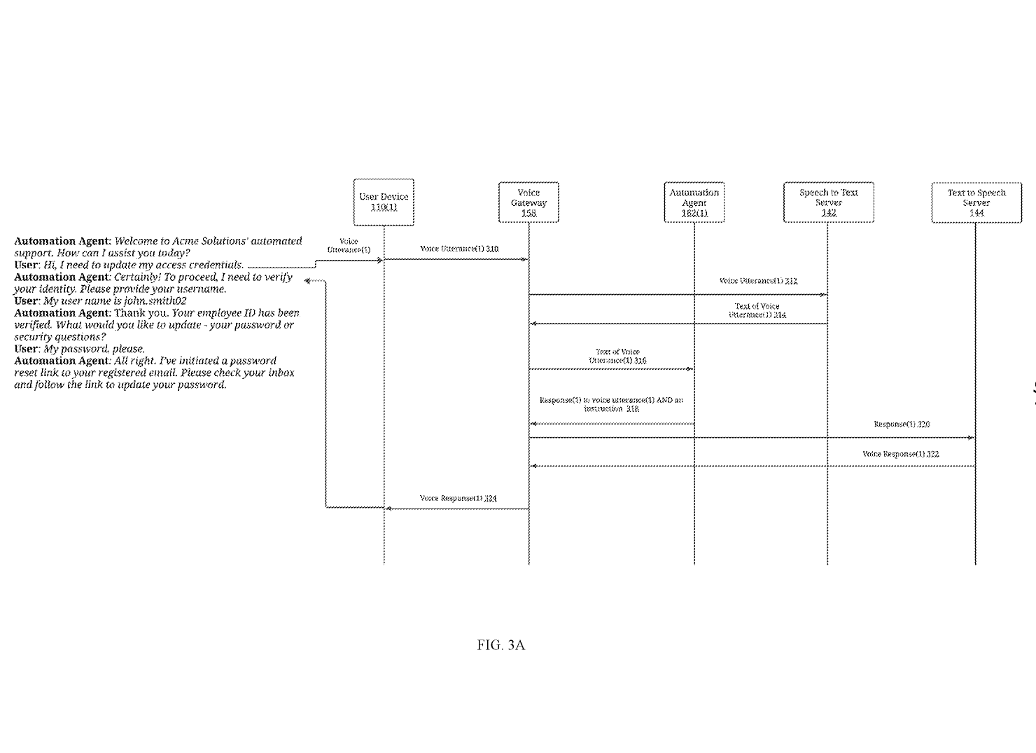

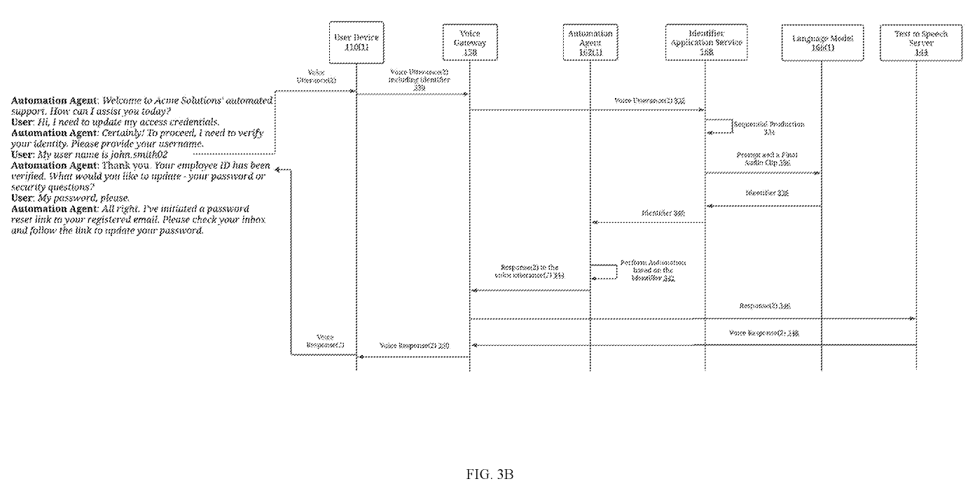

Accordingly, the memory 154 of the automation server 150 can store one or more applications that can include computer executable instructions that, when executed by the automation server 150, causes the automation server 150 to perform actions, such as to transmit, receive, or otherwise process voice data or text data, for example, and to perform other actions described and illustrated below with reference to FIGS. 2, 3A and 3B. The one or more applications can be implemented as modules or components of another application. Further, the one or more applications can be implemented as operating system extensions, modules, plugins, or the like. Even further, the one or more applications may be operative in a cloud-based computing environment. The one or more applications can be executed within one or more virtual machines or one or more virtual servers that may be managed in a cloud-based computing environment. Also, the one or more applications, including the automation server 150 itself, may be located in one or more virtual servers running in a cloud-based computing environment rather than being tied to one or more specific physical network computing devices. Also, the one or more applications may be running in one or more virtual machines executing on the automation server 150.

As illustrated in FIG. 1, the memory 154 comprises one or more applications such as a voice gateway 158, an automation agent platform 160, a model hub 164, an identifier application service 168, and a database 190, although the memory 154 may comprise other types and/or numbers of applications. In one example, the memory 154 may also include a natural language processing (NLP) engine (not shown). One or more components of the memory 154 may be operatively coupled and communicate with each other. The automation server 150 receives communication from the one or more user devices 110(1)-110(n) and provides responses to the communication.

The voice gateway 158 enables communications in voice mode with the automation server 150. The voice gateway 158 handles incoming voice calls from the one or more user devices 110(1)-110(n), and responds to these voice calls based on a voice program aligned with the communication routing setup of the automation server 150. The voice program may be a script in a scripting language such as voice extensible markup language (VXML). The voice gateway 158 interacts with the one or more applications of the automation server 150, the one or more user devices 110(1)- 110(n), the STT server 142, and the TTS server 144 to drive user conversations. In one example, the voice gateway 158 may comprise a SIP orchestrator (not shown) and a media manager (not shown), although there may be other types and/or numbers of components in other examples. The SIP orchestrator orchestrates communication with various components and the media manager manages all the media for the voice gateway 158 and orchestrates with the STT server 142, and the TTS server 144. In one example, the voice gateway 158 may be a web service. The voice gateway 158 may support standards and/or formats such as, for example, JavaScript Object Notation (JSON), voiceXML, Call Control eXtensible Markup Language (CCXML), or Speech Application Language Tags (SALT), although other types and/or numbers of formats may be supported by the voice gateway 158 in other examples.

The automation agent platform 160 enables one or more developers at the one or more developer devices 130(1)-130(n) to configure and deploy one or more automation agents 162(1)-162(n), for example, through tools and interfaces designed for defining use cases, dialog flows, agentic flows, and interaction rules. The automation agent platform 160 comprises application code and configuration corresponding to the one or more automation agents 162(1)-162(n). The one or more developers tailor the one or more automation agents 162(1)-162(n) to specific business requirements using graphical user interfaces or APIs, although other types and/or numbers of methods may be used in other examples. In one example, the one or more automation agents 162(1)-162(n) may be artificial intelligence agents with perception, reasoning, action, and learning capabilities, although there may be other types and/or numbers of capabilities in other examples.

The one or more automation agents 162(1)-162(n) may be powered by one or more language models 166(1)-166(n). A model hub 164 hosts and manages the one or more language models 166(1)-166(n) and provides a user interface for the one or more developer devices 130(1)-130(n) to train, fine-tune, configure, or deploy the one or more language models 166(1)-166(n). The one or more language models 166(1)-166(n) may perform tasks including determining alphanumeric identifiers, interpreting customer utterances, identifying intents, and generating appropriate responses. The one or more language models 166(1)-166(n) may be lightweight models or large language models. The one or more language models 166(1)-166(n) within the model hub 164 can handle diverse input types, including text, images, or multimodal data that combines text, voice, and other media. In one example, the language model 166(1) may be a multi-modal large language model and the automation agent 162(1) may communicate with the language model 166(1) for determining alphanumeric identifiers.

The identifier application service 168 is a software module capable of performing audio processing operations. The identifier application service 168 is configured to receive voice utterances, perform one or more audio processing steps on the received voice utterance, and output one or more audio outputs. These steps may include, but are not limited to, trimming silent portions greater than a predefined threshold and modifying: a frame rate, a frequency, and a pitch, although other types and/or numbers of steps may be performed. In one example, the identifier application service 168 may be a web service.

The database 190 is a repository for storing and organizing information. The database 190 may be a relational database, such as a structured query language database, a NoSQL database, a streaming database, a distributed database, a graph database, a time-series database, or other relational or non-relational databases, although the database 190 may comprise other types and/or numbers of databases in other configurations. In one example, the database 190 may be hosted external to the memory 154, for example, a cloud database hosted and/or managed by a cloud computing service which offers the cloud database as a service.

The database 190 may store alphanumeric identifiers, such as: user identifiers - emails and usernames, product identifiers - product names and product codes, or order identifiers, although other types and/or numbers of alphanumeric identifiers may be stored in other examples. In one example, the database 190 comprises data corresponding to the one or more automation agents 162(1)-162(n). The one or more applications of the automation server 150 may query the database 190 and retrieve information, although other types and/or numbers of components external to the automation server 150 may query the database 190 in other examples.

The network interface 156 may include hardware, software, or a combination of hardware and software, enabling the automation server 150 to communicate with the components illustrated in the STT environment 100, although the network interface 156 may enable communications with other types and/or number of components in other examples. In one example, the network interface 156 provides interfaces between the automation server 150 and the network 180. The network interface 156 may support wired or wireless communications. In one example, the network interface 156 may include an Ethernet adapter or a wireless network adapter to communicate with the network 180.

An enterprise user, such as a developer or a business analyst at one of the one or more developer devices 130(1)-130(n) by way of example, may create or configure the one or more automation agents 162(1)-162(n) using the automation agent platform 162 of the automation server 150. In one example, when a user at, for example, the user device 110(1) communicates with the automation server 150 via a user interface of the automation agent 162(1), the automation server 150 may provide a response to the user communication by communicating with the one or more applications of the automation server 150 or one or more other components of the STT environment 100 to provide the response to the user, although the response may be provided by communicating with other types and/or numbers of applications or components in other examples.

The speech-to-text (STT) server 142 receives one or more voice utterances from the voice gateway 158 and transcribes the one or more voice utterances to generate one or more text outputs which are provided to the voice gateway 158. The text-to-speech (TTS) server 144 receives one or more text inputs from the voice gateway 158 and converts the one or more text inputs into one or more speech outputs which are provided to the voice gateway 158. In one example, the STT server 142 and the TTS server 144 may be hosted and/or managed by the automation server 150.

FIG. 2 is a flowchart of an exemplary method 200 for context aware transcription of identifiers. The exemplary method 200 may be performed by the system components illustrated in the STT environment 100 of FIG. 1. In one example, the user at the user device 110(1) initiates a voice call with an automation agent 162(1) of the automation server 150.

At step 202, the automation server 150 receives the voice call from the user device 110(1). The automation agent 162(1) may greet the user at the user device 110(1) and process the voice call in real time. In one example, the voice call may be an interactive voice response call and the automation server 150 may host and/or manage the interactive voice response system that uses the automation agent 162(1) to provide responses to the user device 110(1).

At step 204, during the voice call, the automation server 150 may request the user at the user device 110(1) to provide an identifier which may be a: (a) user identifier such as a user name, an email id, employee identifier, (b) a product identifier such as a product code, (c) an order identifier, or any other alphanumeric or other identifier, although other types and/or numbers of identifiers may be requested in other examples. In one example, the automation server 150 may provide a prompt – “Please provide your user name” to the user device 110(1). After outputting the request, the automation server 150 instructs the voice gateway 158 to transmit the subsequent voice utterance received from the user device 110(1) to the identifier application service 168.

At step 206, the automation server 150 receives the voice utterance comprising the identifier in response to the request to provide the identifier. The voice gateway 158 transmits the voice utterance to the identifier application service 168 of the automation server 150 in this example.

At step 208, the identifier application service 168 of the automation server 150 sequentially produces a sequence of intermediate audio outputs based on the received utterance, wherein each of the intermediate audio outputs is provided as an input to a next one in the sequential production. Operations in the sequential production comprise: trimming silent portions greater than a predefined threshold; reducing a frame rate; boosting a frequency; or raising a pitch, although other types and/or numbers of operations may be performed in other examples. In one example, the identifier application service 168 receives the voice utterance and trims the silent portions in the voice utterance which are greater than the predefined threshold, and creates a first intermediate audio output. In this example, the silent portions more than the predefined threshold of one second may be trimmed. Next, the identifier application service 168 reduces the frame rate of the first intermediate audio output to create a second intermediate audio output. In this example, the frame rate may be reduced by half. Subsequently, the identifier application service 168 may boost the frequency of the second intermediate audio output to create a third intermediate audio output. The frequency may be boosted to improve clarity of spoken words and reduce the impact of background noise. In this example, the frequency may be boosted by 8000Hz. Further, the identifier application service 168 may raise the pitch of the third intermediate audio output to create a fourth intermediate audio output. The pitch may be raised to emphasize syllable and character intonation. In this example, the pitch may be raised by 30 percentage. It may be understood that the operations in the sequential production may involve different values or value ranges used to carry out the operations in other examples.

Subsequently, at step 210, the identifier application service 168 of the automation server 150 generates a final audio output by combining the intermediate audio outputs. In this example, the identifier application service 168 combines the first intermediate audio output, the second intermediate audio output, the third intermediate audio output, and the fourth intermediate audio output to generate the final audio output. The identifier application service 168 may, in the final audio output, add audio separators between two or more of the intermediate audio outputs. For example, the final audio output may comprise a high-pitched beep or a tone between the first intermediate audio output, the second intermediate audio output, the third intermediate audio output, and the fourth intermediate audio output. The audio separator may comprise any other machine recognizable audio which enables the language model to determine each of the intermediate audio outputs.

At step 212, the identifier application service 168 of the automation server 150 determines with one of the one or more language models 166(1)-166(n) the identifier from the final audio output. In this example, a language model 166(1) may be used to determine the identifier from the final audio output. The language model 166(1) may be a multi-modal language model, although other types and/or numbers of language models may be used in other examples. The identifier application service 168 provides the final audio output along with a prompt instructing the language model 166(1) to determine the identifier and receives a transcribed text of the identifier from the language model 166(1). The identifier application service 168 provides the transcribed text of the identifier to the automation agent 162(1).

At step 214, the automation agent 162(1) of the automation server 150 performs an automation based on the transcribed text of the determined identifier. In one example, when the automation server 150 determines that the requested identifier is from a known list of values in the database 190, the automation server 150 queries the determined identifier in the database 190 to locate an exact match. If no exact match is found, the automation server 150 employs a closest- match logic which is used to determine a closest match. The determined identifier is updated to the value of the closest match. It may be understood that similarity algorithms, predefined thresholds, or heuristic methods may be used to determine the closest match, although other types and/or numbers of methods may be used in other examples.

The automation agent 162(1) may perform the automation based on the updated identifier. In one example, the automation server 150 may deliver an audio of the updated identifier to the user device 110(1) to receive user confirmation through the user device 110(1). The audio of the updated identifier may comprise a pronunciation of each character of the identifier individually. The automation server 150 may perform the automation subsequent to receiving the user confirmation of the updated identifier.

The automation may be an authentication, an execution of a task, execution of dialog flow tasks or agentic tasks, for example, for: autonomously raising support tickets, retrieving and displaying information, enabling tasks like tracking order statuses, setting up reminders, or scheduling appointments, although other types and/or numbers of automations may be performed in other examples.

FIG. 3A is an exemplary interaction diagram illustrating a voice call between the automation server 150 and the user device 110(1). At step 310, the user at the user device 110(1) provides a voice utterance(1) to the voice gateway 158 of the automation server 150. At step 312, the voice gateway 158 provides the voice utterance(1) to the STT server 142. At step 314, the STT server 142 provides a text of the voice utterance(1) to the voice gateway 158. At step 316, the voice gateway 158 provides the text of the voice utterance(1) to the automation agent 162(1) which generates a response(1) to the text of the voice utterance(1). As the response(1), includes a request to provide an identifier, the automation agent 162(1), at step 318, outputs the response(1) and an instruction to the voice gateway 158. The instruction may include a flag, a variable value, text, or any other parameter or value recognized by the voice gateway 158 as a directive to provide the next voice utterance received from the user device 110(1) to the identifier application service 168. At step 320, the voice gateway 158 provides the response(1) to the TTS server 144. The TTS server 144 converts the text of the response(1) to a voice response(1) and at step 322, provides the voice response(1) to the voice gateway 158. At step 324, the voice gateway 158 outputs the voice response(1) to the user device 110(1).

FIG. 3B is another exemplary interaction diagram illustrating a voice call between the automation server 150 and the user device 110(1). At step 330, replying to the response(1) of FIG. 3A, the user at the user device 110(1) provides a voice utterance(2) including an identifier to the voice gateway 158 of the automation server 150. At step 332, the voice gateway 158 provides the voice utterance(2) to the identifier application service 168. At step 334, the identifier application service 168 sequentially produces intermediate audio outputs and generates a final audio output as described above at steps 208 and 210 of FIG. 2. At step 336, the identifier application service 168 provides the final audio output and a prompt to the language model 166(1). In this example, the prompt may include an instruction to determine the identifier from the final audio output. In another example, the prompt provided to the language model 166(1) may comprise a description of: a task to be performed, instructions to perform the task, an identifier format, the final audio output including a description of the operations in the sequential production of the intermediate audio outputs, an example transcription of the identifier based on an example transcription of each of the intermediate audio outputs. The components of the prompt provided to the language model 166(1) are further illustrated below.

An exemplary task description may be: You are provided with an audio file comprising multiple versions of a spoken identifier. Your task is to accurately transcribe this identifier. Exemplary instructions for performing the task may be: 1. Listen carefully to the audio file. 2. Analyze all four versions of the identifier within the audio. 3. Transcribe the identifier in the format “firstname.lastname.” If there is any ambiguity between the versions, provide the most likely transcription. If the identifier cannot be determined, return “none.”

An example description of the identifier format may be: the identifier is in the format “<firstname><optional number>.<lastname><optional number>” (e.g., john.smith, john12.smith, john.smith09 or john04.smith56). An example description of the final audio output including a description of the operations in the sequential production of the intermediate audio outputs may be: The audio file comprises four versions of the spoken identifier separated by short beeps. Operations were performed on a voice utterance comprising the spoken identifier to create each of the four versions. The operations were performed to enhance the clarity of the spoken identifier. The order of the operations is as follows: 1. first intermediate audio output: the initial voice utterance trimmed to remove leading and trailing silences. 2. second intermediate audio output: first intermediate audio output with reduced playback speed (lower frame rate). 3. third intermediate audio output: second intermediate audio output with increased frequency (effectively raising the volume) and noise reduction applied. 4. fourth intermediate audio output: third intermediate audio output with increased pitch to further clarify syllable intonations. These four intermediate outputs are combined into the audio file, with a short beep sound inserted between each intermediate output to mark the transition.

The language model 166(1) determines the identifier from the final audio output and at step 338, the language model 166(1) provides the identifier to the identifier application service 168. At step 340, the identifier application service 168 provides the identifier to the automation agent 162(1). At step 342, the automation agent 162(1) performs an automation based on the identifier and generates a response(2) to the voice utterance(2). In this example, the automation agent 162(1) verifies the user name “john.smith02” and generates the response(2). At step 344, the automation agent 162(1) provides the response(2) to the voice gateway 158. At step 346, the voice gateway 158 provides the response(2) to the TTS server 144. The TTS server 144 converts the text of the response(2) to a voice response(2) and at step 348, provides the voice response(2) to the voice gateway 158. At step 350, the voice gateway 158 outputs the voice response(2) to the user device 110(1).

As described with reference to FIG. 3A and FIG. 3B, the automation server 150 uses the STT server 142 and the TTS server 144 for speech-to-text conversion and text-to-speech conversion respectively during the voice calls. However, when the identifier is requested from the user device 110(1), the automation server 150 uses the identifier application service 168 for speech-to-text conversion. In this manner, the automation server 150 performs context aware transcription of identifiers. This results in improved accuracy of identifier recognition as opposed to the off-the-shelf transcription services. The above-described methods and systems also results in: higher containment of calls within the one or more automation agents 162(1)-162(n), reduced wait time for callers due to reduced reliance on human agents for authentication or determination of identifiers, usage of existing business methods and automation methods for contact centers of enterprises.

Having thus described the basic concept of the invention, it will be rather apparent to those skilled in the art that the foregoing detailed disclosure is intended to be presented by way of example only, and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for determining an identifier in a voice communication session comprising:
receiving, by an automation server, from a user device, a voice utterance comprising an identifier in response to a request to provide the identifier;
sequentially producing, by the automation server, a sequence of intermediate audio outputs based on the received voice utterance, wherein each of the intermediate audio outputs is provided as an input to a next one in the sequential production;
generating, by the automation server, a final audio output by combining the intermediate audio outputs;
determining, by the automation server, with a language model the identifier from the final audio output; and
performing, by the automation server, an automation based on a transcribed text of the determined identifier.

2. The method of claim 1, wherein the voice communication session is an interactive voice response communication session.

3. The method of claim 1, wherein the identifier is an alphanumeric identifier.

4. The method of claim 1, further comprising:
transcribing, by the automation server, voice data received prior to the requesting and subsequent to the determining using a first speech to text system different from an identifier application service performing the sequential production.

5. The method of claim 1, further comprising:
instructing, by the automation server, upon requesting the identifier and prior to the receiving the voice utterance, a voice gateway to transmit the voice utterance to an identifier application service.

6. The method of claim 1, wherein the sequentially producing comprises: trimming silent portions greater than a predefined threshold and modifying: a frame rate, a frequency, and a pitch.

7. The method of claim 1, further comprising:
prior to the performing, updating, by the automation server, the transcribed text of the identifier by querying a database,
wherein the performing the automation is based on the updated transcribed text.

8. An automation server for determining an identifier in a voice communication session:
one or more processors; and
a memory coupled to the one or more processors which are configured to execute programmed instructions stored in the memory to:
receive, from a user device, a voice utterance comprising an identifier in response to a request to provide the identifier;
sequentially produce a sequence of intermediate audio outputs based on the received voice utterance, wherein each of the intermediate audio outputs is provided as an input to a next one in the sequential production;
generate a final audio output by combining the intermediate audio outputs;
determine with a language model the identifier from the final audio output; and
perform an automation based on a transcribed text of the determined identifier.

9. The automation server of claim 8, wherein the voice communication session is an interactive voice response communication session.

10. The automation server of claim 8, wherein the identifier is an alphanumeric identifier.

11. The automation server of claim 8, wherein the one or more processors are further configured to execute the programmed instructions stored in the memory to: transcribe voice data received prior to the requesting and subsequent to the determining using a first speech to text system different from an identifier application service performing the sequential production.

12. The automation server of claim 8, wherein the one or more processors are further configured to execute the programmed instructions stored in the memory to: instruct, upon requesting the identifier and prior to the receive the voice utterance, a voice gateway to transmit the voice utterance to an identifier application service.

13. The automation server of claim 8, wherein the sequential production comprises: trimming silent portions greater than a predefined threshold and modifying: a frame rate, a frequency, and a pitch.

14. The automation server of claim 8, wherein the one or more processors are further configured to execute the programmed instructions stored in the memory to:
prior to the perform, update, by the automation server, the transcribed text of the identifier by querying a database,
wherein the perform the automation is based on the updated transcribed text.

15. A non-transitory computer readable medium storing instruction which when executed by one or more processors, causes the one or more processors to:
receive, from a user device, a voice utterance comprising an identifier in response to a request to provide the identifier as part of a voice communication session;
sequentially produce a sequence of intermediate audio outputs based on the received voice utterance, wherein each of the intermediate audio outputs is provided as an input to a next one in the sequential production;
generate a final audio output by combining the intermediate audio outputs;
determine with a language model the identifier from the final audio output; and
perform an automation based on a transcribed text of the determined identifier.

16. The non-transitory computer readable medium of claim 15, wherein the voice communication session is an interactive voice response communication session.

17. The non-transitory computer readable medium of claim 15, wherein the identifier is an alphanumeric identifier.

18. The non-transitory computer readable medium of claim 15, further comprising instructions which when executed by the one or more processors, causes the one or more processors to: transcribe voice data received prior to the requesting and subsequent to the determining using a first speech to text system different from an identifier application service performing the sequential production.

19. The non-transitory computer readable medium of claim 15, further comprising instructions which when executed by the one or more processors, causes the one or more processors to: instruct, upon requesting the identifier and prior to the receive the voice utterance, a voice gateway to transmit the voice utterance to an identifier application service.

20. The non-transitory computer readable medium of claim 15, wherein the sequential production comprises: trimming silent portions greater than a predefined threshold and modifying: a frame rate, a frequency, and a pitch.

21. The non-transitory computer readable medium of claim 15, further comprising instructions which when executed by the one or more processors, causes the one or more processors to:
prior to the perform, update, by the automation server, the transcribed text of the identifier by querying a database,
wherein the perform the automation is based on the updated transcribed text.
